(19) United States
(12) Patent Application Publication
(10) Pub. No.: US 2024/0243417 A1
(43) Pub. Date: Jul. 18, 2024

(54) BATTERY PACK

(71) Applicant: MURATA MANUFACTURING CO., LTD., Kyoto (JP)

(72) Inventors: Harish KHERDE, Kyoto (JP); Yohei NAGARA, Kyoto (JP)

(21) Appl. No.: 18/387,982

(22) Filed: Nov. 8, 2023

(30) Foreign Application Priority Data
Jan. 16, 2023 (JP) 2023-004718

(51) Int. Cl. H01M 50/291; H01M 50/213; H01M 50/26

(52) U.S. Cl. CPC H01M 50/291; H01M 50/213; H01M 50/26

(57) ABSTRACT

A battery pack is provided and includes: a secondary battery; and a storage portion that has a cylindrical shape with an axis and accommodates the secondary battery, an inner peripheral surface of the storage portion being a tapered surface that has an inclination in which a diameter of the inner peripheral surface increases from a side of the first end toward a side of the second end in the direction of the axis, the storage portion having a groove that extends in the direction of the axis on an outer peripheral surface, a bottom surface of the groove being a tapered surface that has an inclination in which a depth of the groove increases from the side of the first end toward the side of the second end in the direction of the axis, and in a sectional shape of the storage portion taken along a first plane including the axis and a deepest point of the groove, a second angle formed by the axis and a second intersection line of the first plane and the bottom surface being larger than a first angle formed by the axis and a first intersection line of the first plane and the inner peripheral surface.

### CROSS REFERENCE TO RELATED APPLICATIONS

The present application claims priority to Japanese patent application no. 2023-004718, filed on Jan. 16, 2023, the entire contents of which are incorporated herein by reference.

### BACKGROUND

The present disclosure relates to a battery pack.

A sealed battery is described and including a columnar battery case in which an electrode body and an electrolyte solution are sealed. The battery case (case) has a cleavage groove (groove) that is cleaved by an increase in the internal pressure of the case. Since the case is cleaved from the groove as a starting point, an increase in the internal pressure of the case is suppressed, the case is prevented from being cleaved from an unintended location, and the safety of the sealed battery is ensured.

### SUMMARY

The present disclosure relates to a battery pack.

In a battery pack including a cylindrical secondary battery and a cylindrical case which accommodates the secondary battery, similarly to the sealed battery according to Japanese Patent Application Laid-Open No. 2012-59667, a groove that is cleaved by an increase in the internal pressure of the case is disposed on the case in order to ensure safety.

In addition, it is desired that in such a battery pack, the secondary battery is held in a state where vibration of the secondary battery is suppressed in the case, that is, the holding property of the secondary battery is ensured. Therefore, in a battery pack having a cylindrical case that accommodates a cylindrical secondary battery, it is necessary to ensure the safety of the battery pack and to ensure the holding property of the secondary battery.

The present disclosure relates to providing, in an embodiment, both safety of a battery pack and a holding property of a secondary battery in the battery pack including a cylindrical case which accommodates the cylindrical secondary battery.

A battery pack according to an embodiment of the present disclosure includes: a secondary battery having a cylindrical shape; a first case having a cylindrical shape with an axis, the first case having a storage portion in which a first end in a direction of the axis is closed and a second end in the direction of the axis is opened, the storage portion accommodating the secondary battery; and a second case that closes an opening of the storage portion and is joined to the first case, an inner peripheral surface of the storage portion being a tapered surface that has an inclination in which a diameter of the inner peripheral surface of the storage portion increases from a side of the first end toward a side of the second end in the direction of the axis, the storage portion having a groove that extends in the direction of the axis on an outer peripheral surface, a bottom surface of the groove being a tapered surface that has an inclination in which a depth of the groove in a radial direction orthogonal to the axis increases from the side of the first end toward the side of the second end in the direction of the axis, and in a sectional shape of the storage portion taken along a plane including the axis and a deepest point of the groove, a second angle formed by the axis and a second intersection line of the plane and the bottom surface of the groove being larger than a first angle formed by the axis and a first intersection line of the plane and the inner peripheral surface of the storage portion.

According to the present disclosure of an embodiment, in a battery pack including a cylindrical case which accommodates a cylindrical secondary battery, it is possible to achieve both the safety of the battery pack and the holding property of the secondary battery.

### BRIEF DESCRIPTION OF THE FIGURES

FIG. 1 is a perspective view of a battery pack according to an embodiment of the present disclosure;

FIG. 2 is a sectional view of a first case taken along an axial direction of the first case;

FIG. 3 is an enlarged perspective view of the first case showing a groove;

FIG. 4 is an enlarged sectional view of a portion of FIG. 2 showing details of the groove; and

FIG. 5 is an enlarged sectional view of the first case taken along a second plane which is perpendicular to the axis and includes an end of the groove on a second end side of a storage portion, showing details of the groove.

### DETAILED DESCRIPTION

Hereinafter, one or more embodiments will be described in further detail including with reference to the drawings. Note that the present disclosure is not limited to the embodiments. It goes without saying that the embodiments are examples, and partial replacement or combination of the configurations shown in the different embodiments and modifications is possible.

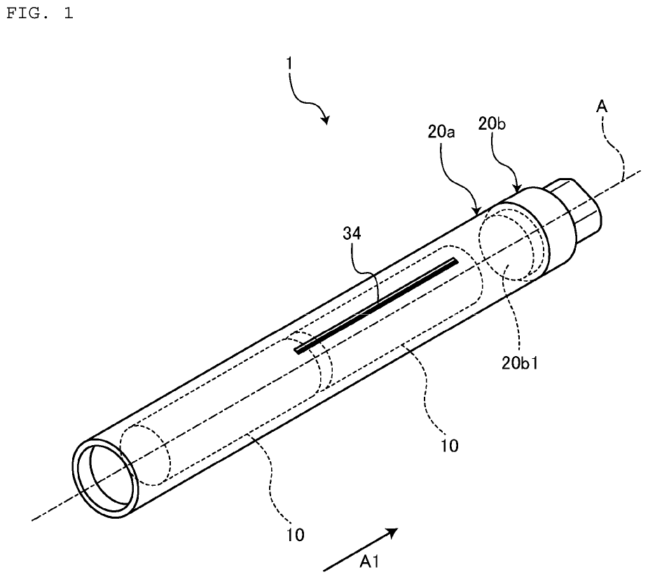

FIG. 1 is a perspective view of a battery pack 1 according to an embodiment of the present disclosure. The battery pack 1 can be applied as a power source to an external device (not illustrated) such as an electric transmission gear of a bicycle. The battery pack 1 can be electrically connected to a charging device (not illustrated). The battery pack 1 includes a secondary battery 10, a first case 20a, and a second case 20b. Note that an axis A shown in the drawing is a central axis of a storage portion 30 (to be described later) included in the first case 20a. A direction along the axis A is referred to as an axial direction A1.

The secondary battery 10 is, for example, a lithium ion battery. The secondary battery 10 has a cylindrical shape. The battery pack 1 includes two secondary batteries 10. The two secondary batteries 10 are arranged in a state of being electrically connected to each other in series. It goes without saying that the number of secondary batteries 10 is not limited to two.

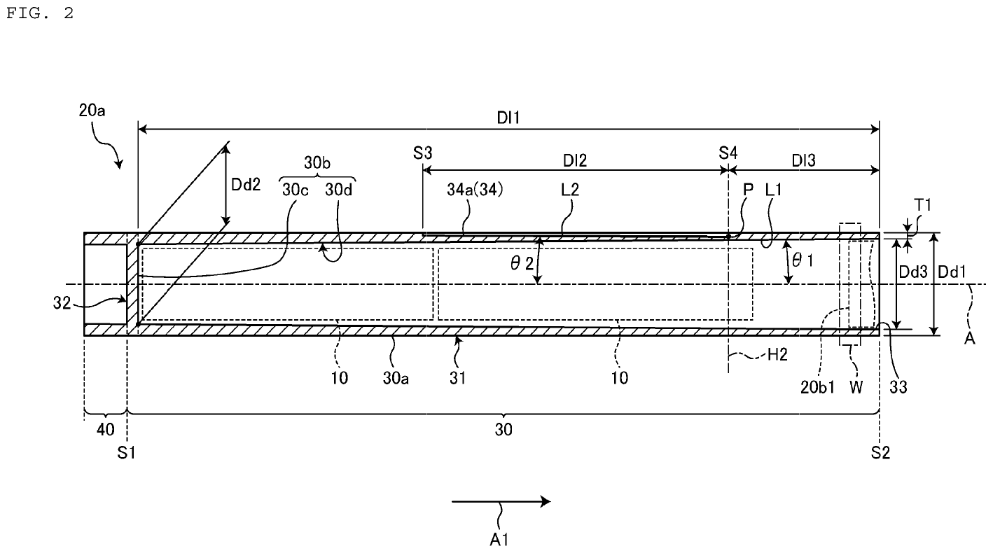

FIG. 2 is a sectional view of the first case 20a along the axial direction A1 of the first case 20a. The first case 20a has the storage portion 30 for storing the secondary battery 10 and an extension portion 40. The storage portion 30 and the extension portion 40 are integrated.

The storage portion 30 has a cylindrical shape having the axis A. The storage portion 30 extends along the axial direction A1 which is a direction along the axis A. In the axial direction A1, an end on one side of the storage portion 30 is referred to as a first end S1, and an end on the other side of the storage portion 30 is referred to as a second end S2. In the storage portion 30, the first end S1 in the axial direction A1 is closed, and the second end S2 in the axial direction A1 is opened. The storage portion 30 will be described in detail later.

The extension portion 40 has a cylindrical shape with the axis A as a central axis, and is disposed integrally with the storage portion 30 on the first end S1 side of the storage portion 30. The first case 20a may not include the extension portion 40.

The second case 20b shown in FIG. 1 has a cylindrical shape that closes an opening (a cavity 33 to be described later) of the first case 20a. The material of the first case 20a and the second case 20b is a thermoplastic resin. The material of the first case 20a and the second case 20b is, for example, a simple substance of polyethylene terephthalate. The material of the first case 20a and the second case 20b may be a synthetic resin containing at least one of polyethylene terephthalate, polypropylene, and polyethylene. The first case 20a and the second case 20b are formed by injection-molding using a mold.

The second case 20b is joined to the first case 20a. Specifically, the first case 20a and the second case 20b are joined to each other by laser welding or vibration welding, for example. Specifically, as shown in FIGS. 1 and 2, the second case 20b has an insertion portion 20b1 inserted into an inner side of the storage portion 30, and the insertion portion 20b1 and an inner peripheral surface 30d, which will be described later, of the storage portion 30 are joined to each other. The joint portion W between the first case 20a and the second case 20b is positioned between the second end S2 of the storage portion 30 corresponding to the inner side of the storage portion 30 in the axial direction A1 and a groove 34 to be described later. When the first case 20a and the second case 20b are joined to each other, the storage portion 30 is hermetically sealed.

The battery pack 1 further includes a positive electrode terminal (not illustrated) electrically connected to the positive electrode of the secondary battery 10 and a negative electrode terminal (not illustrated) electrically connected to the negative electrode of the secondary battery 10 in the storage portion 30. The two secondary batteries 10 are electrically connected in series between the positive electrode terminal and the negative electrode terminal.

The positive electrode terminal and the negative electrode terminal penetrate the second case 20b in a state where airtightness of the storage portion 30 is ensured, and a part of the positive electrode terminal and a part of the negative electrode terminal are exposed from the second case 20b in a manner of being electrically connectable to an external device and a charging device. The two secondary batteries 10 are charged and discharged via the positive electrode terminal and the negative electrode terminal.

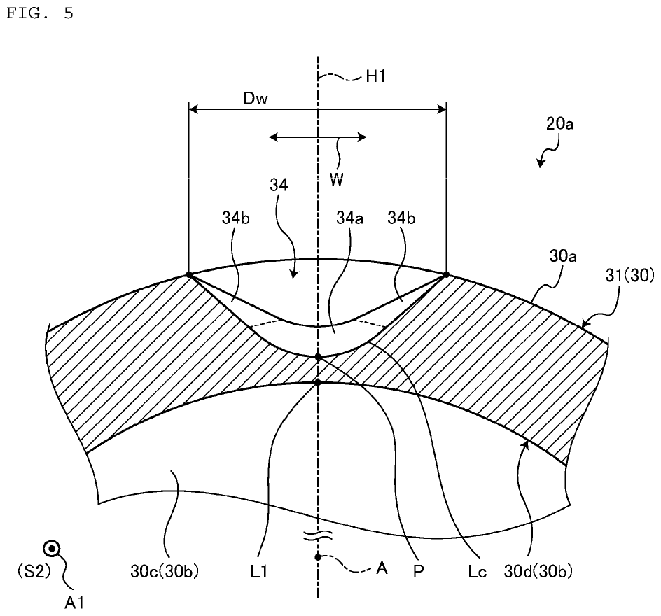

Next, the storage portion 30 shown in FIG. 2 will be described in detail. FIG. 2 illustrates a sectional shape of the first case 20a taken along a first plane H1 (see FIG. 5 to be described later) that includes the axis A and intersects a bottom surface 34a of the groove 34 to be described later.

The storage portion 30 has a peripheral side wall 31, an end wall 32 on the first end S1 side of the storage portion 30, and the cavity 33 that opens on the second end S2 side of the storage portion 30. The peripheral side wall 31 and the end wall 32 are integral with each other. The end of the end wall 32 on the first end S1 side corresponds to the first end S1 of the storage portion 30, and the end of the peripheral side wall 31 on the second end S2 side corresponds to the second end S2 of the storage portion 30.

In the axial direction A1, a diameter Dd1 of an outer peripheral surface 30a of the storage portion 30 is constant. The outer peripheral surface 30a of the storage portion 30 is a surface including the outer peripheral surface of the peripheral side wall 31 and the outer peripheral surface of the end wall 32.

The inner side surface 30b of the storage portion 30 has an inner end surface 30c and an inner peripheral surface 30d. The inner end surface 30c corresponds to the inner end surface on the first end S1 side of the inner side of the storage portion 30. Specifically, the inner end surface 30c is the surface of the end wall 32 on the second end S2 side, and is orthogonal to the axis A.

The inner peripheral surface 30d of the storage portion 30 corresponds to the inner peripheral surface of the peripheral side wall 31. A peripheral edge of the inner peripheral surface 30d on the first end S1 side is connected to a peripheral edge of the inner end surface 30c. The inner peripheral surface 30d extends in the axial direction A1 from the inner end surface 30c to the second end S2 of the storage portion 30. The inner peripheral surface 30d is a tapered surface having an inclination in which the diameter of the inner peripheral surface 30d increases from the first end S1 side toward the second end S2 side in the axial direction A1. In the present embodiment, the diameter Dd2 of the end of the inner peripheral surface 30d on the first end S1 side corresponds to the diameter of the inner end surface 30c.

The magnitude of the first angle θ1 formed by the axis A and the first intersection line L1 of the inner peripheral surface 30d and the first plane H1 corresponds to the magnitude of the so-called draft angle of the mold.

The diameter Dd2 of the end of the inner peripheral surface 30d on the first end S1 side is smaller than the diameter Dd3 of the end of the inner peripheral surface 30d on the second end S2 side.

On the other hand, the diameter of the outer peripheral surface of the secondary battery 10 is constant in the axial direction A1 of the secondary battery 10. Therefore, the difference between the diameter of the inner peripheral surface 30d and the diameter of the outer peripheral surface of the secondary battery 10 increases from the first end S1 side toward the second end S2 side of the inner peripheral surface 30d. The ratio of the difference between the diameter of the inner peripheral surface 30d and the diameter of the outer peripheral surface of the secondary battery 10 to the diameter Dd1 of the outer peripheral surface 30a is 0.023 or more and 0.073 or less.

In addition, the storage portion 30 has the groove 34 extending in the axial direction A1 on the outer peripheral surface 30a. The groove 34 has a concave shape recessed from the outer peripheral surface 30a toward the axis A.

The groove 34 is located inward of the two ends of the storage portion 30 in the axial direction A1. That is, an end of the groove 34 on the first end S1 side (hereinafter may be referred to as a third end S3) is closer to the first end S1 side than the second end S2 of the storage portion 30, and an end of the groove 34 on the second end S2 side (hereinafter may be referred to as a fourth end S4) is closer to the second end S2 side than the first end S1 of the storage portion 30.

In the axial direction A1, a ratio of a length Dl2 of the groove 34 to a length Dl1 of the storage portion 30 from the inner end surface 30c to the second end S2 of the storage portion 30 is 0.32 or more and 0.42 or less.

In the axial direction A1, a ratio of a length Dl3 of the storage portion 30 from the second end S2 of the storage portion 30 to an end (fourth end S4) of the groove 34 on the second end S2 side to the length Dl1 of the storage portion 30 is 0.19 or more and 0.29 or less. Due to the relation among the lengths Dl1, Dl2, Dl3 described above, the groove 34 is located in the peripheral side wall 31.

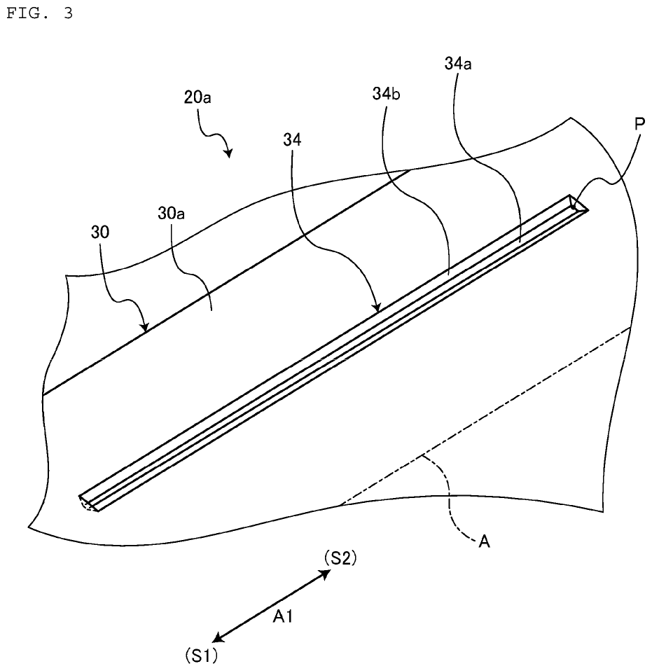

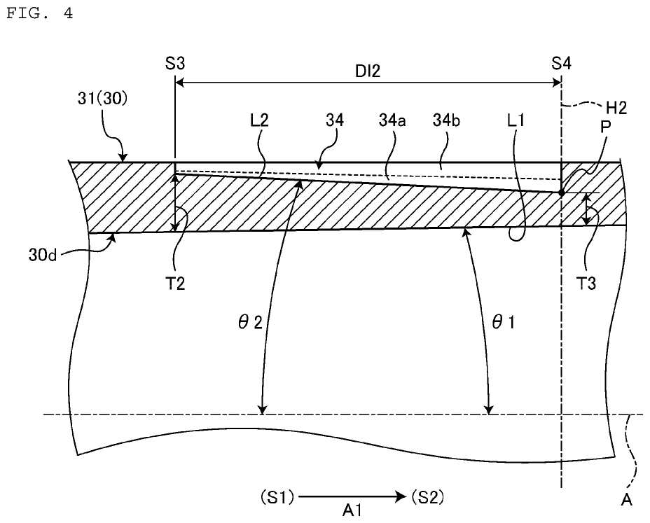

FIG. 3 is an enlarged perspective view of the first case 20a showing the groove 34. FIG. 4 is an enlarged sectional view of a portion of FIG. 2 showing details of the groove 34. That is, FIG. 4 is an enlarged view of a sectional shape of the storage portion 30 taken along the first plane H1 (see FIG. 5). FIG. 5 is an enlarged sectional view of the first case 20a taken along a second plane H2 (see FIGS. 2 and 4) that is orthogonal to the axis A and includes the end (fourth end S4) of the groove 34 on the second end S2 side of the storage portion 30, and shows details of the groove 34.

As shown in FIGS. 3, 4, and 5, the groove 34 has a shape that opens outward in the radial direction of the storage portion 30. The radial direction is a direction orthogonal to the axial direction A1. The radially inner side is the side toward the axis A. The radially outer side is the side away from the axis A.

As shown in FIG. 5, the groove 34 has a plane-symmetrical shape with the first plane H1 as a symmetry plane. That is, a second intersection line L2 (see FIGS. 2 and 4) of the groove 34 and the first plane H1 indicates the depth of the groove 34. The first plane H1 passes through a point (deepest point P to be described later; see FIGS. 2, 3, 4, 5) where the depth of the groove 34 is the deepest on the bottom surface 34a. That is, the sectional shape of the storage portion 30 shown in FIGS. 2 and 4 is a sectional shape taken along the first plane H1 including the deepest point P of the groove 34 and the axis A.

As shown in FIG. 5, the groove 34 has a shape in which the width increases from the inner side toward the outer side in the radial direction of the storage portion 30. The width of the groove 34 is the length of the groove 34 in a direction (direction indicated by an arrow W in FIG. 5) perpendicular to both the axial direction A1 and the radial direction. That is, the width of the groove 34 on the radially outer side is longer than the width of the groove 34 on the radially inner side.

The width Dw of the groove 34 on the outer peripheral surface 30a of the storage portion 30 is constant in the axial direction A1. In other words, the width Dw of the groove 34 at the radially outer end of the groove 34 is constant over the entire groove 34 in the axial direction A1. The ratio of the width Dw of the groove 34 to the diameter Dd1 of the outer peripheral surface 30a is 0.047 or more and 0.062 or less.

In addition, the groove 34 has a bottom surface 34a and two connection surfaces 34b.

The bottom surface 34a has a plane-symmetrical shape with the first plane H1 as a symmetry plane. The bottom surface 34a is a curved surface recessed from the outer peripheral surface 30a of the storage portion 30 toward the axis A. An intersection line between a plane orthogonal to the axis A and the bottom surface 34a of the groove 34 has an arc shape. For example, in the first case 20a shown in FIG. 5 taken along the second plane H2 orthogonal to the axis A, an intersection line Lc between the second plane H2 and the bottom surface 34a of the groove 34 has an arc shape.

A curvature radius of the bottom surface 34a, that is, a curvature radius of the intersection line between the plane orthogonal to the axis A and the bottom surface 34a is constant (for example, 0.1 mm) in the axial direction A1. The curvature radius of the bottom surface 34a is a value which is 0.1 mm or more and 0.3 mm or less.

The two connection surfaces 34b are respectively disposed on both sides of the bottom surface 34a in the circumferential direction of the storage portion 30. The two connection surfaces 34b and the bottom surface 34a are connected in a smoothly continuous state. The two connection surfaces 34b have a plane-symmetrical shape with respect to each other with the first plane H1 as a symmetry plane, and are flat surfaces.

As shown in FIGS. 4 and 5, the depth of the groove 34 in the radial direction increases from the first end S1 side toward the second end S2 side. The bottom surface 34a of the groove 34 is a tapered surface having an inclination such that the depth of the groove 34 in the radial direction orthogonal to the axis A increases from the first end S1 side toward the second end S2 side in the axial direction A1.

As shown in FIGS. 2 and 4, the diameter of the inner peripheral surface 30d increases and the depth of the groove 34 in the radial direction increases from the first end S1 side toward the second end S2 as described above. In other words, the point where the depth of the groove 34 is the deepest is the deepest point P (see FIGS. 2 and 5) where the fourth end S4 of the bottom surface 34a and the first plane H1 intersect with each other.

In addition, in the portion of the storage portion 30 where the groove 34 is disposed, a thickness of the storage portion 30 gradually becomes thinner from the first end S1 side toward the second end S2 side. A thickness T1 (see FIG. 2) of the storage portion 30 at the second end S2 is greater than the thickness of the portion of the storage portion 30 where the groove 34 is disposed. Thus, the thickness of the storage portion 30 is the thinnest at the portion of the storage portion 30 corresponding to the fourth end S4 of the groove 34.

For a thickness T2 of the storage portion 30 corresponding to the end (third end S3) of the groove 34 on the first end S1 side shown in FIG. 4, the ratio of the thickness T2 of the storage portion 30 to the diameter Dd1 of the outer peripheral surface 30a is 0.041 or more and 0.054 or less.

For a thickness T3 of the storage portion 30 corresponding to the end (fourth end S4) of the groove 34 on the second end S2 side, the ratio of the thickness T3 of the storage portion 30 to the diameter Dd1 of the outer peripheral surface 30a is 0.017 or more and 0.027 or less. The thickness of the end wall 32 is equal to or greater than the thickness of the portion of the storage portion 30 where the groove 34 is disposed. That is, the thickness T3 of the storage portion 30 corresponding to the fourth end S4 of the groove 34 corresponds to the smallest thickness in the storage portion 30.

Further, a second angle θ2 formed by the axis A and the second intersection line L2 of the bottom surface 34a of the groove 34 and the first plane H1 is larger than the first angle θ1 formed by the axis A and the first intersection line L1 of the inner peripheral surface 30d and the first plane H1. A ratio of the second angle θ2 to the first angle θ1 is 1.4 or more and 4.25 or less.

Thus, by making the second angle θ2 larger than the first angle θ1, it is possible to suppress an increase in the diameter of the inner peripheral surface 30d while thinning the thickness at the portion of the storage portion 30 corresponding to the fourth end S4 of the groove 34. Thus, it is possible to prevent the gap between the inner peripheral surface 30d and the secondary battery 10 from becoming large, and it is possible to reduce the Vibration of secondary battery 10 in the storage portion 30. That is, the holding property of the secondary battery 10 in the first case 20a can be ensured.

Next, the function of the groove 34 will be described.

For example, when the internal pressure of the storage portion 30 increases due to gas or the like ejected from the secondary battery 10 due to abnormal heat generation of the secondary battery 10, the storage portion 30 is cleaved from the groove 34 as a starting point. Specifically, the internal pressure of the storage portion 30 uniformly acts on the inner peripheral surface 30d on the side closer to the first end S1 than the joint portion W which is between the first case 20a and the second case 20b. Thus, stresses caused by an increase in the internal pressure of the storage portion 30 are concentrated at a portion of the storage portion 30 in the vicinity of the fourth end S4 of the groove 34, which corresponds to the thinnest portion of the storage portion 30. Thus, the storage portion 30 is cleaved starting from the vicinity of the fourth end S4 corresponding to the bottom surface 34a of the groove 34. Further, the storage portion 30 is cleaved from the vicinity of the fourth end S4 corresponding to the bottom surface 34a toward the first end S1 side along the bottom surface 34a of the groove 34, that is, in the axial direction A1. Thus, the area of the opening formed by the cleavage of the storage portion 30 increases, and the force of the air ejected from the inside of the storage portion 30 to the outside of the storage portion 30 can be suppressed.

In addition, the smallest thickness T3 (see FIG. 4) of the storage portion 30 is defined to be a thickness such that the storage portion 30 is cleaved when the internal pressure of the storage portion 30 is equal to or higher than a predetermined internal pressure. The predetermined internal pressure is defined according to an experiment or the like performed in advance. The predetermined internal pressure is a pressure at which the safety of the battery pack 1 can be ensured. The predetermined internal pressure is lower than the internal pressure of the storage portion 30 at which the joint portion W (see FIG. 2) between the first case 20a and the second case 20b is broken. That is, when the internal pressure of the storage portion 30 increases, the storage portion 30 is cleaved from the vicinity of the fourth end S4 corresponding to the bottom surface 34a, and the joint portion W between the first case 20a and the second case 20b is not cleaved.

In addition, the bottom surface 34a of the groove 34 and the inner peripheral surface 30d of the storage portion 30 are tapered surfaces that minimize the thickness T3 of the storage portion 30 among the thicknesses of the storage portion 30, as described above. With the above-described configuration, when the internal pressure of the storage portion 30 increases, the storage portion 30 can be cleaved in the vicinity of the fourth end S4 corresponding to the bottom surface 34a, as described above. Thus, the safety of the battery pack 1 can be ensured.

Next, with reference to Table 1 and Table 2, the effect of the shape of the groove 34 that can be adopted in the battery pack 1 will be described in detail.

Table 1 shows the results of an internal pressure increase test on the battery pack 1 of the present embodiment and a battery pack of a comparative example.

### [Table 1]

TABLE 1

| | Curvature | | | Thickness | | |
|---|---|---|---|---|---|---|
| | Radius of | | Length | T3 of | | |
| | Bottom | Second | D12 of | Storage | Cleavage Pressure | |
| | Surface 34a | Angle θ2 | Groove 34 | Portion 30 | Actual | |
| | (mm) | (°) | (mm) | (mm) | Product | Simulation |
| Battery | 0.3 | 0.45 | 51 | 0.4 | 192 | 165 |
| Pack 1 | | | | | | |
| Battery | 0 | 0 | 96 | 0.35 | 100 | 97 |
| Pack of | | | | | | |
| Comparative | | | | | | |
| Example | | | | | | |

In Table 1, the curvature radius of the bottom surface 34a, the second angle θ2, the length Dl2 of the groove 34, and the thickness T3 of the storage portion 30 are indicators for representing the shape of the groove 34 in the battery pack 1 and the battery pack of the comparative example.

The battery pack 1 in Table 1 has the groove 34 where the curvature radius of the bottom surface 34a is 0.30 mm, the second angle θ2 is 0.45°, the length Dl2 of the groove 34 is 51 mm, and the thickness T3 of the storage portion 30 is 0.40.

On the other hand, the battery pack of the comparative example in Table 1 has the groove 34 where the curvature radius of the bottom surface 34a is 0 mm, the second angle θ2 is 0°, the length Dl2 of the groove 34 is 96 mm, and the thickness T3 of the storage portion 30 is 0.35.

Specifically, the groove 34 of the battery pack of the comparative example has a V-shaped section and does not have a curved surface at the bottom. In addition, the bottom of the groove 34 of the battery pack of the comparative example is not inclined with respect to the axis A but is parallel to the axis A.

With respect to the battery pack 1 and the battery pack of the comparative example, an internal pressure increase test using an actual product and a simulation of the internal pressure increase test are performed, and the results are summarized in Table 1.

A method of the internal pressure increase test using an actual product will be described. First, an opening is formed on the end wall 32 of the battery pack 1. Second, a nozzle of an oil supply device is fitted to the opening of the end wall 32, and oil is supplied to increase the internal pressure until the battery pack 1 is cleaved. When the battery pack 1 is cleaved and the internal pressure is suddenly lowered, the oil supply device automatically stops. A cleavage pressure is recorded when the oil supply device stops and the test is terminated.

The simulation of the internal pressure increase test will be described. Using software of a personal computer, the simulation of the internal pressure increase test is performed, and simulation results of the cleavage pressure in the shape of the battery pack 1 and simulation results of the cleavage pressure in the shape of the battery pack of the comparative example are recorded.

Values in the column of the cleavage pressure in Table 1 will be described.

First, the value in the column of the cleavage pressure of the actual product of the battery pack of the comparative example is the value at the time when the result of the internal pressure increase test (measured value of the cleavage pressure) of the actual product of the battery pack of the comparative example is set to 100. Specifically, the value in the column of the cleavage pressure of the actual product of the battery pack of the comparative example is 100.

Second, the value in the column of the cleavage pressure of the actual product of the battery pack 1 is a numerical value indicating the ratio of the result of the internal pressure increase test (measured value of the cleavage pressure) of the actual product of the battery pack 1 to the result of the internal pressure increase test (measured value of the cleavage pressure) of the actual product of the battery pack of the comparative example. Specifically, the value in the column of the cleavage pressure of the actual product of the battery pack 1 is 192.

Third, the value in the column of the cleavage pressure of the simulation of the battery pack of the comparative example is a numerical value indicating the ratio of the numerical value of the simulation result of the internal pressure increase test of the battery pack of the comparative example to the test result (measured value of the cleavage pressure) of the actual product of the battery pack of the comparative example. Specifically, the value in the column of the cleavage pressure in the simulation of the battery pack of the comparative example is 97.

Finally, the value in the column of the cleavage pressure of the simulation of the battery pack 1 is a numerical value indicating the ratio of the numerical value of the simulation result of the internal pressure increase test of the battery pack 1 to the result of the internal pressure increase test (measured value of the cleavage pressure) of the actual product of the battery pack of the comparative example. Specifically, the value in the column of the cleavage pressure of the simulation of the battery pack 1 is 165.

Here, the value in the column of the cleavage pressure of the actual product is 100 in the battery pack of the comparative example, whereas it increases to 192 in the battery pack 1. In addition, the value in the column of the cleavage pressure of the simulation is 97 in the battery pack of the comparative example, whereas it increases to 165 in the battery pack 1. Thus, in the battery pack of the comparative example and the battery pack 1, the value in the column of the cleavage pressure of the actual product and the value in the column of the cleavage pressure of the simulation are in a proportional relation. Corresponding to the battery pack of the comparative example, the value in the column of the cleavage pressure of the actual product and the value in the column of the cleavage pressure of the simulation are approximate to each other. The value in the column of the cleavage pressure of the actual product of the battery pack 1 is close to the value of the cleavage pressure of the simulation of the battery pack 1. Based on these facts, it can be said that there is a correlation between the values in the columns of cleavage pressure of actual products and the values in the columns of simulation. In other words, it can be said that the simulation result of the internal pressure increase test can be close to the result of the internal pressure increase test of the actual product.

Table 2 shows simulation results, etc. of the internal pressure increase test.

### [Table 2]

TABLE 2

| | Curvature | | | Thickness T3 | | Breaking |
|---|---|---|---|---|---|---|
| | Radius of | Second | Length D12 | of Storage | | Strength |
| Sample | Bottom Surface | Angle θ2 | of Groove | Portion 30 | Cleavage | of Joint |
| Number | 34a (mm) | (°) | 34 (mm) | (mm) | Pressure | Portion W |
| 1 | 0.3 | 0.45 | 51 | 0.3 | 108 | 382 |
| 2 | 0.3 | 0.28 | 51 | 0.45 | 188 | |
| 3 | 0.3 | 0.28 | 51 | 0.45 | 188 | |
| 4 | 0.3 | 0.85 | 40 | 0.3 | 120 | |
| 5 | 0.1 | 0.5 | 51 | 0.3 | 120 | |
| 6 | 0.3 | 0.5 | 51 | 0.3 | 103 | |
| 7 | 0 | 0 | 96 | 0.35 | 97 | |

In Table 2, “1” to “6” of “Sample Number” correspond to the battery pack 1 of the present embodiment. “7” of “Sample Number” corresponds to the battery pack of the comparative example in Table 1.

“Curvature Radius of Bottom Surface 34a”, “Second Angle θ2”, “Length Dl2 of Groove 34”, and “Thickness T3 of Storage Portion 30” (Minimum Thickness of Storage Portion 30) in Table 2 are indicators for representing the shape of the groove 34 corresponding to each of the battery packs of “1” to “7” of “Sample Number”.

The value in the column of the cleavage pressure of Sample Number 7 is a numerical value indicating the ratio of the numerical value of the simulation result of the internal pressure increase test of the battery pack of the comparative example to the test result (measured value of the cleavage pressure) of the actual product of the battery pack of the comparative example shown in Table 1. Specifically, the value in the column of the cleavage pressure of Sample Number 7 is 97.

The values in the columns of the cleavage pressure of Sample Numbers 1 to 6 are numerical values indicating the ratios of the cleavage pressures of Sample Numbers 1 to 6 respectively to the cleavage pressure of Sample Number 7.

“Breaking Strength of Joint Portion W” in Table 2 will be described. The breaking strength of the joint portion w is a value indicating an internal pressure at the time when the joint portion W (see FIG. 2) between the first case 20a and the second case 20b breaks due to an increase in the internal pressure of the battery pack 1. In Table 2, the value in the column of the breaking strength of the joint portion W is a numerical value indicating the ratio of the breaking strength of the joint portion W to the cleavage pressure of Sample Number 7.

When the internal pressure of the battery pack 1 increases and the joint portion W breaks before the groove 34 is cleaved, there is a risk that an object accommodated in the battery pack 1 (such as the secondary battery 10) may jump out from the battery pack 1 to the outside. In this case, there is a risk that the safety of the battery pack 1 may be impaired. On the other hand, when the internal pressure of the battery pack 1 increases and the groove 34 is cleaved before the joint portion W breaks, gas can be released from the cleaved portion of the groove 34 to the outside of the battery pack 1 before the joint portion W breaks, and the breakage of the joint portion w can be suppressed. Therefore, in the battery pack 1, the groove 34 is required to be cleaved before the joint portion W breaks. In other words, it is required that the cleavage pressure in Table 2 is lower than the breaking strength of the joint portion W in Table 2.

Referring to Table 2, the values in the columns of the cleavage pressure of Sample Numbers 1 to 6 are each significantly lower than the values in the columns of the breaking strength of the joint portion W. That is, in the battery pack 1 of each of Sample Numbers 1 to 6, the internal pressure of the battery pack 1 increases and the groove 34 is cleaved before the joint portion W breaks. Therefore, the safety of the battery pack 1 can be ensured.

Next, another effect of the shape of the groove 34 that can be adopted in the battery pack 1 will be described with reference to Table 3 and Table 4.

It is desirable that the storage portion 30 is not damaged when the battery pack 1 is dropped, and it is desirable that the groove 34 is not cleaved. Hereinafter, effects of the battery pack 1 when the battery pack 1 is dropped will be described with reference to Table 3 and Table 4.

Table 3 shows the results of a drop test on the battery pack 1 of the present embodiment and the battery pack of the comparative example.

### [Table 3]

TABLE 3

| | Curvature | | | Thickness | | | |
|---|---|---|---|---|---|---|---|
| | Radius of | | Length | T2 of | | | Maximum |
| | Bottom | Second | D12 of | Storage | | Result of | Stress of |
| | Surface | Angle | Groove | Portion | Width Dw | Actual | Groove 34 |
| | 34a (mm) | θ2 (°) | 34 (mm) | 30 (mm) | (mm) | Product | (Simulation) |
| Battery | 0.3 | 0.45 | 51 | 0.8 | 1.03 | No | 41.8 |
| Pack 1 | | | | | | Cleavage | |
| Battery | 0 | 0 | 96 | 0.53 | 1.03 | Cleavage | 100 |
| Pack of | | | | | | Present | |
| Comparative | | | | | | | |
| Example | | | | | | | |

In Table 3, the curvature radius of the bottom surface 34a, the second angle θ2, the length Dl2 of the groove 34, the thickness T2 of the storage portion 30, and the width Dw are indicators for representing the shape of the groove 34 in the battery pack 1 and the battery pack of the comparative example.

The battery pack 1 in Table 3 has the groove 34 where the curvature radius of the bottom surface 34a is 0.30 mm, the second angle θ2 is 0.45°, the length Dl2 of the groove 34 is 51 mm, the thickness T2 of the storage portion 30 is 0.80 mm, and the width Dw is 1.03 mm.

On the other hand, the battery pack of the comparative example in Table 3 has the groove 34 where the curvature radius of the bottom surface 34a is 0 mm, the second angle θ2 is 0°, the length Dl2 of the groove 34 is 96 mm, the thickness T2 of the storage portion 30 is 0.53 mm, and the width Dw is 1.03 mm. Specifically, the groove 34 of the battery pack of the comparative example has a V-shaped section and does not have a curved surface at the bottom. In addition, the bottom of the groove 34 of the battery pack of the comparative example is not inclined with respect to the axis A but is parallel to the axis A. The thickness T2 of the storage portion 30 corresponding to the battery pack of the comparative example is thinner than the thickness T2 of the storage portion 30 corresponding to the battery pack 1.

With respect to the battery pack 1 and the battery pack of the comparative example, a drop test using an actual product and a simulation of the drop test are performed, and the results are summarized in Table 3.

A method of the drop test using an actual product will be described. In the drop test, a lightweight drop tester DT-205H (manufactured by Yoshida Seiki Inc.; hereinafter referred to as drop tester) is used. The battery pack 1 is attached to the drop tester in a manner that the groove 34 of the battery pack 1 faces a drop surface on which concrete is laid, and the battery pack 1 is dropped from a predetermined height. The battery pack 1 after dropping is visually checked for the presence or absence of cleavage of the groove 34. The above-described test is repeated 3 times, and when cleavage of the groove 34 is confirmed, the battery pack 1 is determined as “Cleavage Present” (NG determination), and when cleavage of the groove 34 is not confirmed, the battery pack 1 is determined as “No Cleavage” (OK determination).

The simulation of the drop test will be described. In the simulation of the drop test, the battery pack 1 is dropped from a position at a predetermined height in a vertical direction from a floor surface. The predetermined height is a height of the battery pack 1 in a state in which the battery pack 1 is used.

The column of the result of the actual product in Table 3 shows the result of the drop test using the actual product. Specifically, “No Cleavage” indicates a case where the groove 34 is not cleaved. “Cleavage Present” indicates a case where the groove 34 is cleaved. That is, when the battery pack 1 is dropped from the predetermined height, the groove 34 is still not cleaved. On the other hand, when the battery pack of the comparative example is dropped from the predetermined height, the groove 34 is cleaved.

Values in the column of the maximum stress (simulation) of the groove 34 in Table 3 will be described.

First, the value in the column of the maximum stress (simulation) of the groove 34 corresponding to the battery pack of the comparative example is a value at the time when the value of the simulation result of the drop test of the battery pack of the comparative example is set to 100. Specifically, the value in the column of the maximum stress (simulation) of the groove 34 corresponding to the battery pack of the comparative example is 100.

Second, the value in the column of the maximum stress (simulation) of the groove 34 corresponding to the battery pack 1 is a numerical value indicating the ratio of the value of the simulation result of the drop test of the battery pack 1 to the value of the simulation result of the drop test of the battery pack of the comparative example. Specifically, the value in the column of the maximum stress (simulation) of the groove 34 corresponding to the battery pack 1 is 41.8.

It can be said that in view of the column of the result of the actual product and the column of the maximum stress (simulation) of the groove 34 in Table 3, a result is obtained in which the groove 34 is still not cleaved when the battery pack 1 is dropped in the simulation of the drop test in a case where the value in the column of the maximum stress (simulation) of the groove 34 is 41.8 or less.

Next, Table 4 will be described. Table 4 shows simulation results of the drop test.

### [Table 4]

TABLE 4

| | Curvature | | | | | |
|---|---|---|---|---|---|---|
| | Radius of | | Length | Thickness T2 | | Maximum |
| | Bottom | Second | D12 of | of Storage | | Stress of |
| Sample | Surface 34a | Angle | Groove 34 | Portion 30 | | Groove 34 |
| Number | (mm) | θ2 (°) | (mm) | (mm) | Width (mm) | (Simulation) |
| 1 | 0.1 | 0.28 | 51 | 0.7 | 1.03 | 38.9 |
| 2 | 0.1 | 0.85 | 40 | 0.9 | 1.03 | 39.7 |
| 3 | 0.1 | 0.45 | 51 | 0.7 | 1.03 | 32.1 |
| 4 | 0.1 | 0.45 | 51 | 0.7 | 0.8 | 35.7 |
| 5 | 0 | 0 | 96 | 0.53 | 1.03 | 100 |

“1” to “4” of “Sample Number” correspond to the battery pack 1 of the present embodiment. “5” of “Sample Number” corresponds to the battery pack of the comparative example in Table 3.

“Curvature Radius of Bottom Surface 34a”, “Second Angle θ2”, “Length Dl2 of Groove 34”, “Thickness T2 of Storage Portion 30” and “Width” in Table 4 are indicators for representing the shape of the groove 34 corresponding to each of the battery packs of “1” to “5” of “Sample Number”.

The value in the column of the maximum stress (simulation) of the groove 34 of Sample Number 5 is a value at the time when the value of the simulation result of the drop test of the battery pack of the comparative example is set to 100. Specifically, the value in the column of the maximum stress (simulation) of the groove 34 of Sample Number 5 is 100.

The values in the column of the maximum stress (simulation) of the groove 34 of Sample Numbers 1 to 4 are values each indicating a ratio to the value of the simulation result of the drop test of the battery pack of the comparative example when the value of the simulation result of the drop test of the battery pack of the comparative example is set to 100.

In the battery pack 1 of the present embodiment (Sample Numbers 1 to 4), the “maximum stress of the groove 34 (simulation)” is less than 41.8 (see Table 3). Therefore, in the battery pack 1 of each of Sample Numbers 1 to 4, the storage portion 30 (groove 34) is prevented from being damaged.

As described above, the bottom surface 34a of the groove 34 is a curved surface, and it is possible to suppress the maximum stress generated by the impact when the battery pack 1 is dropped.

The two ends of the groove 34 are located inward of the two ends of the storage portion 30 in the axial direction A1. Furthermore, the thickness of the storage portion 30 becomes thinner from the first end S1 side toward the second end S2 side in the axial direction A1. Therefore, when the groove 34 extends to the second end S2, the thickness of the storage portion 30 becomes further thinner on the second end S2 side of the storage portion 30. Thus, there is a risk that the groove 34 may be cleaved when the battery pack 1 is dropped.

Therefore, in the battery pack 1 of the present embodiment, the two ends of the groove 34 are located inward of the two ends of the storage portion 30 in the axial direction A1 so that the thickness of the storage portion 30 at the two ends of the storage portion 30 is ensured. Thus, it is possible to prevent the groove 34 from being cleaved when the battery pack 1 is dropped.

Note that the embodiments described above are intended to facilitate understanding of the present disclosure, but not intended to construe the present disclosure in any limited way. The present disclosure may be modified/improved without departing from the spirit thereof, and the present disclosure includes equivalents thereof. Hereinafter, a modification of the battery pack 1 according to the above-described embodiment will be described.

For example, it goes without saying that the above-described ratio (for example, the ratio of the thickness T2 of the storage portion 30 to the diameter Dd1 of the outer peripheral surface 30a of the storage portion 30) is not limited to the above-described value. Also, the width of the groove 34 and the curvature radius of the base of the groove 34 may vary in the axial direction A1. Further, the two connection surfaces 34b may be curved surfaces. The groove 34 may have an asymmetrical shape instead of a plane-symmetrical shape whose symmetry plane is the first plane H1. The first plane H1 may intersect with the bottom surface 34a at a position away from the deepest point P.

In addition, in the storage portion 30 between the first end S1 and the third end S3 in the axial direction A1, the diameter of the outer peripheral surface 30a may be smaller than the diameter Dd1 in a state where the thickness of the storage portion 30 is equal to or greater than the thickness T2.

Further, the first case 20a and the second case 20b may be joined to each other at the second end S2 of the storage portion 30. Furthermore, the first case 20a and the second case 20b may be joined to each other using an adhesive, a screw, or the like. In addition, the battery pack 1 may further include a sealing member (for example, an O-ring) that is disposed on the second case 20b and maintains airtightness of the storage portion 30.

In addition, the inner side surface 30b may have an annular connection surface (not illustrated) that connects a peripheral edge of the inner end surface 30c and a peripheral edge of the inner peripheral surface 30d on the first end S1 side. The diameter of the connection surface increases from the first end S1 side toward the second end S2 side.

In addition, a peripheral edge portion of the inner peripheral surface 30d on the second end S2 side may be chamfered. In this case, the joint portion W between the first case 20a and the second case 20b is located on the first end S1 side with respect to the chamfered portion on the inner side of the storage portion 30, and when the internal pressure of the storage portion 30 increases, the internal pressure of the storage portion 30 does not act on the chamfered portion. When the peripheral edge portion of the inner peripheral surface 30d on the second end S2 side is chamfered, the thickness of the chamfered portion may be smaller than the thickness T3 of the storage portion 30 (see FIG. 4), and the thickness T1 of the storage portion 30 (see FIG. 2) is the thickness of the portion of the storage portion 30 closest to the second end S2 side excluding the chamfered portion.

The storage portion 30 may have two grooves 34. For example, the two grooves 34 are disposed on the outer peripheral surface 30a at positions opposite to each other in the radial direction of the storage portion 30 (positions where the open sides of the grooves 34 face opposite to each other in the radial direction). In this case, when the internal pressure of the storage portion 30 increases, the storage portion 30 is cleaved from at least one of the two grooves 34.

In the battery pack 1 according to the above-described modification of the embodiment, similarly to the embodiment, it is possible to suppress vibration of the secondary battery 10 in the storage portion 30, and when the internal pressure of the storage portion 30 increases, the storage portion 30 is cleaved from the vicinity of the fourth end S4 corresponding to the bottom surface 34a of the groove 34 where stresses are concentrated. In addition, the storage portion 30 is prevented from being damaged when the battery pack 1 is dropped. Therefore, both the safety of the battery pack 1 and the holding property of the secondary battery 10 can be achieved.

Note that the present disclosure may be a combination of the following configurations according to an embodiment.

(1)

A battery pack including:
a secondary battery having a cylindrical shape;
a first case having a cylindrical shape with an axis, the first case having a storage portion in which a first end in a direction of the axis is closed and a second end in the direction of the axis is opened, the storage portion accommodating the secondary battery; and
a second case that closes an opening of the storage portion and is joined to the first case,
an inner peripheral surface of the storage portion being a tapered surface that has an inclination in which a diameter of the inner peripheral surface of the storage portion increases from a side of the first end toward a side of the second end in the direction of the axis,
the storage portion having a groove that extends in the direction of the axis on an outer peripheral surface,
a bottom surface of the groove being a tapered surface that has an inclination in which a depth of the groove in a radial direction orthogonal to the axis increases from the side of the first end toward the side of the second end in the direction of the axis, and
in a sectional shape of the storage portion taken along a plane including the axis and a deepest point of the groove, a second angle formed by the axis and a second intersection line of the plane and the bottom surface of the groove being larger than a first angle formed by the axis and a first intersection line of the plane and the inner peripheral surface of the storage portion.

(2)

The battery pack according to (1), wherein
in the sectional shape of the storage portion taken along the plane, a ratio of a thickness of the storage portion at an end of the groove on the side of the second end to a diameter of the outer peripheral surface of the storage portion is 0.017 or more and 0.027 or less.

(3)

The battery pack according to (1) or (2), wherein
in the sectional shape of the storage portion taken along the plane, a ratio of a thickness of the storage portion at an end of the groove on the side of the first end to a diameter of the outer peripheral surface of the storage portion is 0.041 or more and 0.054 or less.

(4)

The battery pack according to any one of (1) to (3), wherein
a ratio of the second angle to the first angle is 1.4 or more and 4.25 or less.

(5)

The battery pack according to any one of (1) to (4), wherein
the bottom surface of the groove is a curved surface.

(6)

The battery pack according to (5), wherein
a curvature radius of the bottom surface of the groove is 0.1 mm or more and 0.3 mm or less.

(7)

The battery pack according to any one of (1) to (6), wherein
the groove has a shape whose width increases from an inner side toward an outer side in the radial direction of the storage portion.

(8) The battery pack according to any one of (1) to (7), wherein
a width of the groove is constant in the direction of the axis on the outer peripheral surface of the storage portion.

(9)

The battery pack according to (8), wherein
a ratio of the width of the groove on the outer peripheral surface of the storage portion to a diameter of the outer peripheral surface of the storage portion is 0.047 or more and 0.062 or less.

(10)

The battery pack according to any one of (1) to (9), wherein
the groove is located inward of two ends of the storage portion in the direction of the axis.

(11)

The battery pack according to any one of (1) to (10), wherein
in the direction of the axis, a ratio of a length of the groove to a length of the storage portion from an inner end surface on the side of the first end inside the storage portion to the second end of the storage portion is 0.32 or more and 0.42 or less.

(12)

The battery pack according to any one of (1) to (11), wherein
in the direction of the axis, a ratio of a length of the storage portion from the second end of the storage portion to an end of the groove on the side of the second end to a length of the storage portion from an inner end surface on the side of the first end inside the storage portion to the second end of the storage portion is 0.19 or more and 0.29 or less.

(13)

The battery pack according to any one of (1) to (12), wherein
a ratio of a difference between the diameter of the inner peripheral surface of the storage portion and a diameter of an outer peripheral surface of the secondary battery to a diameter of the outer peripheral surface of the storage portion is 0.023 or more and 0.073 or less.

(14)

The battery pack according to any one of (1) to (13), wherein
the storage portion includes two of the grooves, and the two of grooves are opposite to each other in the radial direction.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery pack comprising:
a secondary battery having a cylindrical shape;
a first case having a cylindrical shape with an axis, the first case having a storage portion in which a first end in a direction of the axis is closed and a second end in the direction of the axis is opened, the storage portion accommodating the secondary battery; and
a second case that closes an opening of the storage portion and is joined to the first case,
an inner peripheral surface of the storage portion being a tapered surface that has an inclination in which a diameter of the inner peripheral surface of the storage portion increases from the first end toward the second end in the direction of the axis,
the storage portion having a groove that extends in the direction of the axis on an outer peripheral surface,
a bottom surface of the groove being a tapered surface that has an inclination in which a depth of the groove in a radial direction orthogonal to the axis increases from the first end toward the second end in the direction of the axis, and
in a sectional shape of the storage portion taken along a plane including the axis and a deepest point of the groove, a second angle formed by the axis and a second intersection line of the plane and the bottom surface of the groove being larger than a first angle formed by the axis and a first intersection line of the plane and the inner peripheral surface of the storage portion.

2. The battery pack according to claim 1, wherein
in the sectional shape of the storage portion taken along the plane, a ratio of a thickness of the storage portion at an end of the groove on the side of the second end to a diameter of the outer peripheral surface of the storage portion is 0.017 or more and 0.027 or less.

3. The battery pack according to claim 1, wherein
in the sectional shape of the storage portion taken along the plane, a ratio of a thickness of the storage portion at an end of the groove on the side of the first end to a diameter of the outer peripheral surface of the storage portion is 0.041 or more and 0.054 or less.

4. The battery pack according to claim 1, wherein
a ratio of the second angle to the first angle is 1.4 or more and 4.25 or less.

5. The battery pack according to claim 1, wherein
the bottom surface of the groove is a curved surface.

6. The battery pack according to claim 5, wherein
a curvature radius of the bottom surface of the groove is 0.1 mm or more and 0.3 mm or less.

7. The battery pack according to claim 1, wherein
the groove has a shape whose width increases from an inner side toward an outer side in the radial direction of the storage portion.

8. The battery pack according to claim 1, wherein
a width of the groove is constant in the direction of the axis on the outer peripheral surface of the storage portion.

9. The battery pack according to claim 8, wherein
a ratio of the width of the groove on the outer peripheral surface of the storage portion to a diameter of the outer peripheral surface of the storage portion is 0.047 or more and 0.062 or less.

10. The battery pack according to claim 1, wherein
the groove is located inward of two ends of the storage portion in the direction of the axis.

11. The battery pack according to claim 1, wherein
in the direction of the axis, a ratio of a length of the groove to a length of the storage portion from an inner end surface on the side of the first end inside the storage portion to the second end of the storage portion is 0.32 or more and 0.42 or less.

12. The battery pack according to claim 1, wherein
in the direction of the axis, a ratio of a length of the storage portion from the second end of the storage portion to an end of the groove on the side of the second end to a length of the storage portion from an inner end surface on the side of the first end inside the storage portion to the second end of the storage portion is 0.19 or more and 0.29 or less.

13. The battery pack according to claim 1, wherein
a ratio of a difference between the diameter of the inner peripheral surface of the storage portion and a diameter of an outer peripheral surface of the secondary battery to a diameter of the outer peripheral surface of the storage portion is 0.023 or more and 0.073 or less.

14. The battery pack according to claim 1, wherein
the storage portion includes two of the grooves, and
the two of grooves are opposite to each other in the radial direction.
